(19) United States
(12) Patent Application Publication
(10) Pub. No.: US 2020/0190428 A1
(43) Pub. Date: Jun. 18, 2020

(54) NANOFILTRATION AUTOMATION FOR POLISHING OF OIL RESIN PLANT EXTRACTS

(71) Applicant: Ahmed Anthony Shuja, Oakland, CA (US)

(72) Inventor: Ahmed Anthony Shuja, Oakland, CA (US)

(21) Appl. No.: 16/717,849

(22) Filed: Dec. 17, 2019

Related U.S. Application Data
(63) Continuation of application No. PCT/US19/66672, filed on Dec. 16, 2019.
(60) Provisional application No. 62/780,302, filed on Dec. 16, 2018.

(51) Int. Cl. C11B 3/00; B01D 11/04; B01D 61/14; B01D 61/22; B01D 61/18; B01D 61/02; B01D 61/12; B01D 61/08

(52) U.S. Cl. CPC C11B 3/008; B01D 11/0415; B01D 61/145; B01D 61/22; B01D 2313/50; B01D 61/027; B01D 61/12; B01D 61/08; B01D 2313/18; B01D 61/18

(57) ABSTRACT

A system for purifying cannabis miscella is provided comprising a feed tank enabled to store the miscealla derived from cannabis extraction, a plurality of optical sensor modules, at least one valve, an ultrafiltration membrane module; and at least one pump. Wherein a closed system enabled to maintain a positive or negative pressure created by the at least one pump, enabling moving a flow of the miscealla through the system, one optical sensor is positioned upstream and downstream from the ultrafiltration membrane, the at least one valve is positioned between ultrafiltration membrane and an outlet, and a level of opening the valve creates different levels of back pressure based on readings from the optical sensors.

### CROSS-REFERENCE TO RELATED DOCUMENTS

This application claims priority to U.S. Provisional Patent Application No. 62/780302 entitled “Nanofiltration Automation for Polishing of Oil Resin Plant Extracts”, which was filed on Dec. 16, 2018, the contents of which are expressly incorporated by reference herein.

### BACKGROUND OF THE INVENTION

### 1. Field of the Invention

Automation of a process of refining oil resins by chemical separation using semipermeable membranes. The present inventions relates to refinement of organic oil resins dissolved in solvents by filtering with nanofiltration using new techniques to monitor and control the process with optical sensing.

### 2. Description of the Related Arts

cannabis and hemp processors scale up operations into tons per day of biomass processing there are significant challenges with scaling up oil processing to a large industrial level with the technology that is currently used. A closed-loop extraction system is a system of vessels, connections that involves maintaining pressure at all times and operating control valves. It is typically comprised of a large vessel that holds the solvent, an attached tubular vessel holding biomass for controlled and contained solvent saturation, a recovery tank, and at least a recovery pump.

The system typically incorporates a means for heating the solvent, post extraction and a pump to aid in solvent recovery. During the entire process, the solvent will remain under pressure. A crude oil product is recovered and the used solvent is rendered to a gaseous state via the heat source and pumped into a recovery tank for later use.

With extraction in polar solvents it is common to use a dilution ratio of 1 to 1.5 gallons of solvent per pound of biomass. Typically the biomass for hemp or cannabis will have between 5-30 wt % of active pharmaceutical ingredients (APIs) in the biomass. Example of some of the APIs include THC, THCa, CBD, CBDa and various terpenes. After extraction with all of the oil is diluted in a solvent for post processing usually at 5-10 wt % of a oil/solvent solution. The user may elect to dissolve oil with a 10×-100× dilution ratio between extracted oil and solvent on a wt/volume basis. The solvent may be used for extraction twice or maybe three times depending on the concentration of cannibinoids or other desired extraction product in the starting biomass. This desire to reuse solvents large amount of solvent must be recovered. Currently this is done by way of heating the miscella i.e. oil in solvent and selectively evaporating the solvent under vacuum. Large scaling of this solvent recovery process in an industrial application is costly due to large amounts of electricity used for joule heating, solvent loss during transfers between vessels, and the need for Class 1 Division 2 (C1D2) floor space. In the united states developers must comply with National Fire Protection Association (NFPA) code that spells out how to protect employees form fire hazards and reduce the spreading of fires caused by flammable solvents. At larger industrial processing of over 2000 pounds per day of biomass the cost of Tenant Improvement (TI) can be 2× or more to the cost of the equipment and even higher if the building is required to have a hazard classification for processing closed loop solvent based systems. The oil can be degraded during this process, as well, due to oxidation products formed during miscella (crude oil) heating and cannabinoid degradation can occur. An often overlooked area is also the thermal liability of the highly desired terpenes that can be boiled off during desolvation.

Proceeding desolvation a next step is carried out called winterization where wax, lipids and free fatty acids are removed. This process is also time consuming where oil is often left overnight in a sub-zero cryo-freezer to wait for the wax and some lipids to form crystals and precipitate out of the miscella solution. The idea is that the long chain waxes form crystals as the miscella is allowed to sit for long periods of time or overnight at cold temperatures of −40 C to −100 C. These crystals become large enough that they can be filtered with micron sized filters.

The present invention provides a faster, and cheaper method to scale the steps of winterization a.k.a. “polishing” and desolvation with nanofiltration.

Currently the cannabis and hemp processing industry is moving heavily toward cryo-cooling ethanol before polar solvent extraction by ethanol to keep from pulling wax, lipids, and chlorophyll A&B during extraction. The scaling of the cryo-cooling of ethanol has been explored by the present inventor and found to be prohibitive due to cost and fire safety concerns. The nanofiltration processing equipment will eliminate the need for this cryo-cooling. The disclosed automation scheme will allow the removal of waxes and chlorophyll A & B at room temperature without significant losses of the active cannabinoid compounds. The cryo-cooling at the preceding step will become unnecessary. Solving the problem of industrialized scaling of solvent recovery and polishing crude oil is a key to unlocking the economic scaling of the oil resin industry.

A primary reason for this lack of commercialization is the gap that exist between the polymer science and the industrialization of the process.

There are many obstacles in the art that have prevented large scale use of nanofiltration membranes to polish crude oil from extraction. The selection of a nanofiltration membrane depends upon the amount of pressure and temperature used in the polishing process. As there is an increase in pressure compounds on the boarder of passing a distinct Molecular weight cut-off will begin to permeate after a given pressure is reached. Depending on the polymeric markup of the membrane there are different amounts of swelling and realization in the polymer surface. Thus the initial design pressure may not be sufficient after membranes age thus affecting their dynamic viability and the performance over time.

In the cases where solvent stable nanofiltration membranes are used several challenges arrive in the in-situ monitoring due to flammability of the solvents. This makes conductivity measurements with specific sensors used to determine dissolved solids in solution not possible or extremely difficult.

The present inventor solves much of the above problems related to large scale polishing or purification of crude oil derived from cannabis biomass in an extraction process by implementing a series of optical sensors distributed throughout an industrial nanofiltration process which monitors quantities of APIs in the miscella enabling determination of purity.

### SUMMARY

The process to be carried takes a cannabis, hemp oil or any member of the Cannabaceae family. More broadly on any edible oil extract where full spectrum oils are generated and molecular size difference exits between impurity and smaller target compound. As crude oil comes out of the extraction stage and is diluted at least 10:1 but ranging from 20:1-100:1 to form a miscella (oil in solvent) and passed it through two stages of a spiral wound filter. The flow diagram is detailed in FIG. 1. The first filter has a cutoff of 500-1000 Daltons and is in place to fraction off the larger organic molecules by retaining them (i.e. retentate) wax, lipids and free fatty acids and/or chlorophyll. The miscella feeds into the filter at pressures of 10-40 Bar and then the permeate (penetrates filter) will contain a fraction with cannabinoids. The second stage has a 100-300 Dalton range and is used to retentate (reject) the oil and allow the solvent molecules to pass as permeate. This will desolvate the miscella and bring the ratio from 100:1 to range of 5:1 to 3:1 oil vs. solvent without the use of heating the miscella under vacuum. A series of optical sensors are used in the process to monitor the extent to which the process is complete so the user can feed varying feedstock into the machine and achieve a consistent reduction in unwanted constituents in the mixture.

### BRIEF DESCRIPTION OF THE DRAWINGS

FIG. 1 is a plumbing and instrumentation diagram to show location of optical sensors

FIG. 2 ANSI flange to show optical sensors interacting with miscella flowing within the system

FIG. 3 Sanitary fitting shown with a optical sensor coupled to a sight glass

FIG. 4 Characteristic autofluorescense curve to show range of sensitivity of solution constituents

FIG. 5 Adsorption spectrum to observe the reduction in FFA compared to operational pressure.

FIG. 6 is a table showing the wt % values of FIG. 5.

### DETAILED DESCRIPTION

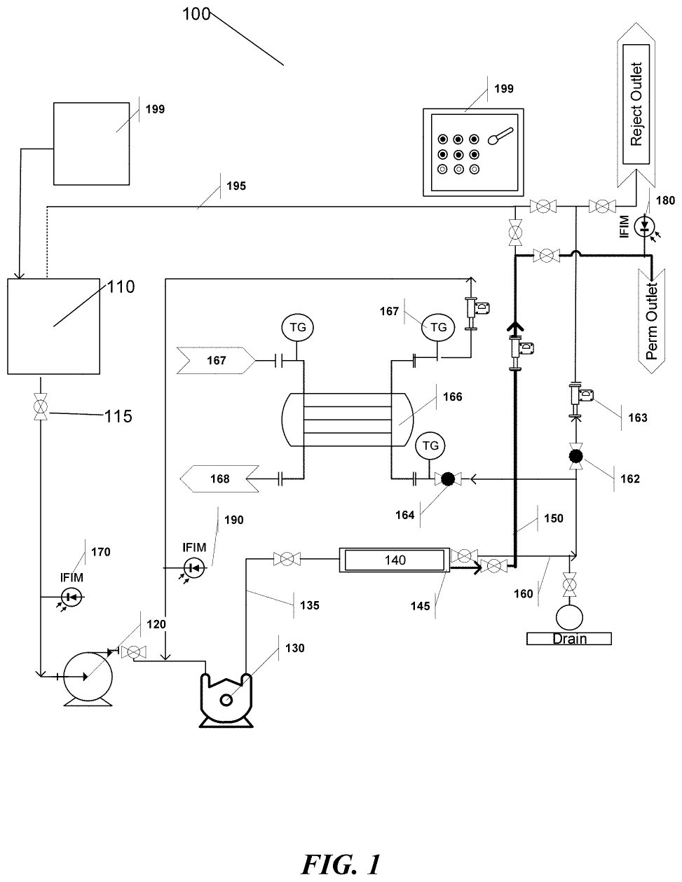

Hardware of the invention will be outfitted with several sensors onboard that are for safety and process control such as temperature and over pressure regulation. In FIG. 1 industrial equipment for carrying out chemical separations of oil resins with organic solvent resistant nanofiltration membranes is described. The filter system 100 starts with a feed tank 110 that holds crude oil that has been extracted with super critical fluid extraction, closed-loop Butane, fluorocarbon, ethanol or any bulk crude oil extraction techniques of the users choice. The resulting crude oil is diluted in organic solvent such as ethanol in a ratio of 10:1 to 100:1 but preferably 20:1. The oil/solvent mix (miscella) is pumped into the machine by a feed pump 120 that boosts that pressure to approximately 10-20 psi in a first stage. Then a high pressure pump 130 further increases the pressure to a bar in a range above 10 bar to 50 bar depending on the nanofiltration or Reverse Osmosis (RO) membrane to be used. A nanofiltration or ultrafiltration (UF) membrane 140 is used for removing wax and lipids by creating a cross flow filter with size exclusion pores that is in the range of 500 dalton to 1000 dalton i.e. single unit nanometer size pores to approximately 100's of nanometer pores that are either a hydrophyllic or hydrophobic membrane. The optimal size will depend on the solvent system and if this solvent system is a polar (hydrophyllic) or non-polar (hydrophobic) solvent system. The crude oil is input and two output streams are created a permeate stream 150 and a retentate outlet stream 160.

The majority of the flow created by the high pressure pump will bypass the filter in the retentate stream. This volume flow rate comparison is between 20:1 to 200:1 retentate flow rate to permeate flow rate. Thus the system is designed to recirculate this flow back through the system by opening valve 164 and passing through heat exchanger 166. This is controlled by using back pressure regulating valves 162 and 164 where the retentate flow is completely recirculated on itself if valve 162 is closed and 164 is open partially. The partial opening of 164 can create back pressure thus getting a desired pressure at the nanofiltration membrane 140 where the chemical seperation is occurring. Along the retentate outlet stream 160 a cross flow heat exchanger 166 is provided that regulates the overall process temperature from 5 C to 35 C. Cooling inlet and outlet 167 and 168 are provided to allow for cold water input 167 and water outlet 168 that has absorbed heat by cross flowing cooling water from water inlet 167 to outlet 168 via an external cooling system.

Further a system of controls or a controller is disclosed where the back pressure in valve 164 can be adjusted based on reading from optical sensors 170, 180, 190 in FIG. 1. based on autofluorescence which are shown. The field of auto fluorescence sensor is the method of choice due lower hardware cost in a first sense. Also a secondary emission is used in the detector to sense constituents in a miscella mixture. This means you are not dependent purely on a statistical correlation model as in IR absorbance via. transmission.

The first optical sensor 170 monitors the feed line where miscella that will be chemically separated flows from tank 110 to membrane 140. A second sensor 180 is put onto the permeate line 150 (i.e. miscealla that makes it past the nanofiltration membrane) to monitor the concentration of the active pharmaceutical ingredient (API)that successfully passed through the membrane. A third sensor 190 will be placed in the retentate or reject line 160 to monitor the build-up of wax lipids and the concentration of the API remaining in the retentate process stream.

A common challenge with nanofiltration occurs in the feed tank when the concentration of the solvent diminishes such that API's concentration increases. This causes a phenomenon called concentration polarization. This high solute to solvent ratio reduces this diffusion length at the surface and reduces permeation of the API. Also with the retentate stream flowing back into the feed tank through line 195 the concentration of the wax and lipids will be increased in the feed tank. The increase of API to solvent causes concentration polarization and the permeation rate of the API will drop off rapidly. To deal with this issue a tank of virgin solvent 199 is used to re-dilute the feed tank. By comparing the autofluorescence reading between sensors 170, 180, and 190 the amount of virgin solvent to be added can be adjusted to optimize for permeation of API. In another embodiment the solvent tank 199 could have an additive to adjust the PH of the solvent. This can promote the crystallization of wax and lipids thus allowing for higher processing rates. This occurs because if the wax and lipids can be crystalized by adjusting the PH to basic, a membrane with several thousand Dalton size pores can be used allowing for higher solvent/to API permeation rates. This can be sensed as well by comparing sensor readings from sensors 170, 180, and 190.

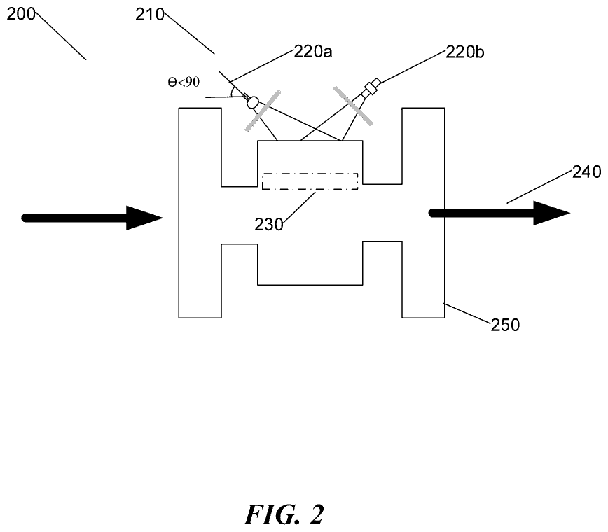

An idealized drawing of an American National Standards Institute (ANSI) flange type fitting is shown in FIG. 2 as 200. A light source 210 preferably a laser source is used with an excitation wavelength between 200 nm-400 nm. Preferably about 350-400 nm is used as an excitation. A light source 210 of low wavelength <400 nm is used at a shallow acute angle less than 90 degrees to the flow of miscella that passes within a pipe fitting 200. The florescence sensor 220 is mounted on the machine with an acute angle compared to a transparent sight glass 230 as the miscella passes through a sanitary pipe fitting 250. The pipe fitting depicted in FIG. 2 is relative to an ANSI 150 type fitting but could also fashioned to couple with other types of pipe fittings. The ANSI flange fittings are rated for maximum pressure by a engineering standard ANSI, B16.5 and can be named by numbers like 150, 300, 400, 600 to be used in increasing pressure scales. Generally after a critical pressure rating Example ANSI 150 a sight glass cannot be used as it may rupture. This done since a surface layer will be penetrated with the incumbent light and cause secondary scattering emission. The sensor 220 is set at a shallow angle to maximize the capture of secondary florescence coming from the molecules in the process stream.

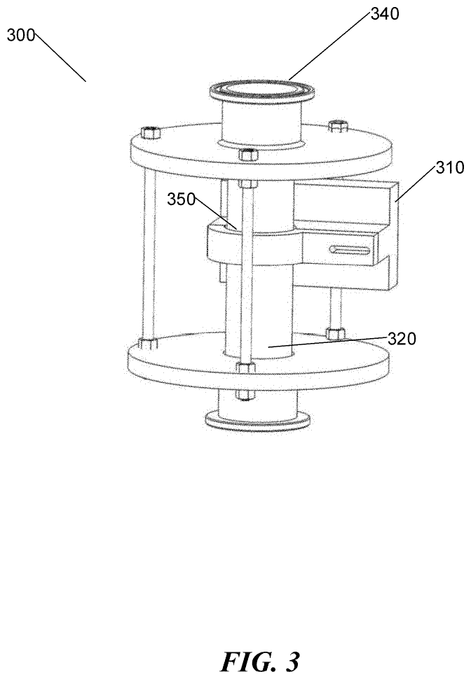

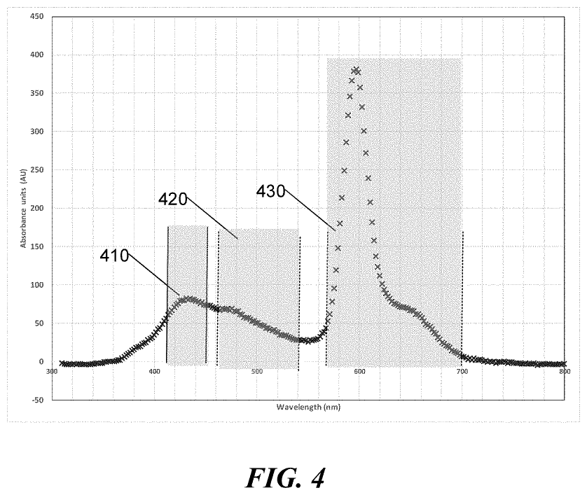

Another embodiment for coupling the AUTO FLORESENCE sensor is coupled to a sanitary fitting that is a chemical process fitting is shown in FIG. 3 at 300 where the autofluorescence sensor 310 is clamped onto a transparent sight glass 320. The sensor depicted is commercially available from Aerometrix of Rockville, Md. The flange is then coupled to the process line via sanitary fittings flanges 340 such that the sensor can be easily placed at the entrance and exit of the process lines. The incident light 350 is emitted from a collar into a clear cylindrical sight glass 320 causes the various mixture components to create secondary emission as shown in FIG. 4 where the secondary emission from the miscella feed. These sensors can be used in the various machine locations shown in FIG. 1 170, 180, 190 to gather readings on the feed, permeate and retentate stream. In FIG. 4 the cannabinoids roughly emit a secondary emission 410-450 nm where the range is depicted as 410. The waxes and lipids will roughly emit at a range of 450-540 nm with a range depicted as 420 and Chlorophyll A & B emit at 650 nm and 700 nm roughly depicted as 430. This new in-situ metrology will leverage this physics to determine the compounds in a miscella stream using an autofluorescence optical sensor during nanofiltration.

The short wavelength excites compounds causing secondary emission that is read by a spectrophotometer. The area under the peck of this secondary emission will change at different stages of the Organic Solvent Nanofiltration (OSN) process. This allows a real time measure of the elimination of long chain waxes, Free Fatty Acid (FFA), or chlorophyll A and chlorophyll B. The presence of cannabinoids can be roughly or perhaps accurately monitored by analyzing these secondary emissions. To monitor concentrations the area under the absorbance curve is calculated and subsequently compared to High Pressure Liquid Chromatography (HPLC) data. A statistical regression model is then used to correlate the data.

Classically, In order to optimize the solution an external HPLC is used to make calibration samples of known concentrations of the API (Active pharmaceutical ingredient) in the desired solvent system. The AUTO FLORESENCE emission spectra are then captured. From this data set a beer-lambert law calculation can provide an approximation of the wt % of the API in the solvent solution. An approximate list of API constituents may include THC, THCa, CBD, CBDa, CBN, CBG, Delta 8 THC, or the many other common cannabinioids.

In order to optimize the reading on FFA, Wax and lipid concentration a similar external measurement technique is used to correlate the concentration of the wax and lipids to the AUTO FLORESENCE readings between 450-540 nm from 320 in FIG. 3. The method disclosed will be compared with an external apparatus to test for the extent of wax removal offered by CDR Food Lab. This system will allow for the processor to quickly take two process fractions, a sample of the permeate and retentate. This technique utilizes a proprietary enzyme to make the long chain wax florescence a purple color. A small cuvette is used and an optical test benchtop unit can be used to measure the C18˜Oleic Acid content in wt %. In organic chemisity hydrocarbons are commonly grouped by the number of carbons in the chain backbone as a rough size of the molecule. This is an offline method for testing the extent to which long chain wax and free fatty acid removal has been completed. This data is compared to AUTO FLORESENCE spectral emission curves to create a beer lambert type of relationship. Furthermore another alternative to testing the FFA content is the American Oil Chemist Society—AOCS CA 5a-40 where a titration is completed by creating a basic solution of solvent EtOH and NaOH. Then the sample is titrated in the presence of a Phenolphthalein thus changing colors at a known pH. These two offline measurements can be used to create a statistical correlation of the concentration of the FFA wt % reduction.

An issue that can occur with the use of broad based spectral analysis is the major absorbance of the incumbent radiation by a high absorber like chlorophyll A & B and thus a dampening of the secondary emission spectral signal in the range desired to evaluate API and FFA. This can be handled by applying a notch filter i.e. a optical filter that has a low and high wavelength cutoff, that cuts the emission signal out below 400 nm and above 600 nm. This method will allow the detector to focus on a signal generated in the range of the cannabinoids and wax/lipids range.

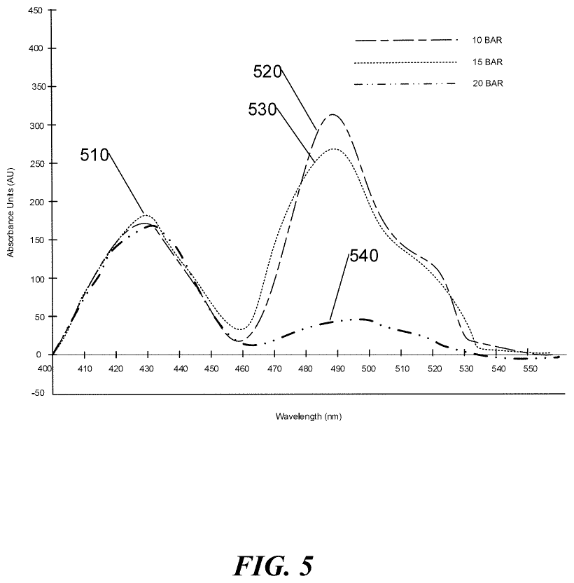

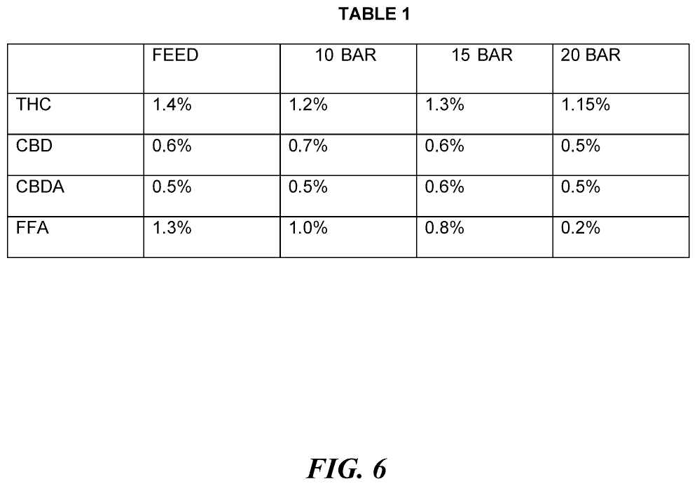

In FIG. 5 a spectral curve is shown using a notch filter where the intent is to reduce the FFA content in the process stream but maintain the API contents of THC, CBD, and CBDA. In the absorption curves the pressure is varied as a primary variable at 10, 15, and 20 Bar, in this example. In FIG. 6 the data from a winterization step by nanofiltration is presented where the to coincide with FIG. 5. In FIG. 5 the portion of absorbance curve that is indicative for the API concentration is noted at 510 and for the three permeate streams i.e. what would be collected from there is not a large amount of variation in the absorbance units. The absorbance at 10 Bar is denoted by 520 where FIG. 6 shows the value is 1 wt % FFA content according to the AOCS CA 5a-40 method. The wt % is calculated relative to a dilution of 20:1 of ETOH to raw crude oil. This means the overall oil content is 5.9% in the solvent. Then as the pressure is increased to 15 Bar the absorbance curve in FIG. 5 is indicated by 530 where the FFA content in the permeate stream is starting to see a reduction to 0.8 wt % in the miscella. In a third permeation pressure test at 20 bar it is found that the absorption curve 540 sees a drop in the range of 450-540 nm and the measurement of FFA according to AOCS CA 5a-40 shows the FFA content is 0.2% in the miscella stream.

This difference in the permeate fractions allows the control system to vary the pressure and flow rate to optimize the allowed permeation of the API and rejection of the wax and lipids in-situ. The can be done by using a VFD (variable frequency drive) pump and a PLC (Programmable logic controller) controlled back pressure regulating valve.

As the solvent passed through the second stage of nanofitration membrane the cannabinoids are found present in the retentate of the desolvation membrane 200 Da & 300 Da in this work, ether membrane could have been used. If there is a fouling of a filter the user will see selectivity go away thus indicating the need for a filter to be changed. Thus with in-situ spectral analysis more accurate preventative maintenance can be performed on the nanofiltration equipment.

The in-situ autofluorescence is providing an in-situ mechanism to monitor the miscella feed as the process streams are different enough that the variation in the compounds can be monitored in time by numerical integration methods of the spectral absorbance curves. This will allow a method to drive the system valving and recycling of the retentate stream until the desired compounds are removed. This will also allow to account the variation in (crude oil variations, which is one the primary current challenges in scaling hemp and cannabis oil resin processing. The different strains of cannabis and hemp have varying amounts of wax/lipid and cannabinoids. Also the chlorophyll content is variable depending on the extraction solvent. This new control method will allow real time analysis if bleaching clays, activated carbon, or cross flow membranes of different Dalton size or polymer makeup. The sensor can be used with other techniques that are used by those skilled in the art for decoloring to see how well the process is working in situ in terms of API loss and rate of chlorophyll A & B removal vs. flow rate and time. The current membrane selection makes this process compatible with a wide range of solvent systems including hexane, heptane, acetone, ethanol, ethanol with 5 wt % heptane. It is anticipated that as the combination of the three fields (crude oil processing, nanofiltration, and in-situ optical sensor processing monitoring) is explored further various combinations of optical filters, signal amplifiers, band pass filters, and signal modulation and demodulation can be used for specific oil constituents vs solvent systems. Furthermore, it may be possible to achieve a similar sensing mechanism with Raman spectroscopy or mass spec but it is uncertain the overall impact on the economics on first cost, and maintenance.

The inclusion of new in-situ metrology during de-waxing, polishing and desolvation will positively affect the processing equipment landscape by reduction operational cost by 50-75% per gram. For winterization currently there is quite a bit of heterogeneity in the raw crude with varying amounts of impurities and long chain waxes.

It will be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the components may be implemented.

What is claimed is:

1. A system for purifying cannabis miscella, comprising;
a feed tank enabled to store the miscealla derived from cannabis extraction;
a plurality of optical sensor modules;
at least one valve;
an ultrafiltration membrane module; and
at least one pump;
wherein a closed system enabled to maintain a positive or negative pressure created by the at least one pump, enabling moving a flow of the miscealla through the system, one optical sensor is positioned upstream and downstream from the ultrafiltration membrane, the at least one valve is positioned between ultrafiltration membrane and an outlet, and a level of opening the valve creates different levels of back pressure based on readings from the optical sensors.

2. The system of claim 1, wherein a control module is provided automatically adjusting the valves based on detected readings from the optical sensors.

3. The system of claim 1, wherein the optical sensor modules include a sanitary pipe fitting with a transparent window and are equipped with a light source enabled to create autofluorescence on the miscella thereby exciting impurities rendering them detectable by the optical sensor modules.

4. The system of claim 3, wherein the impurities include one or more of long chain fatty acids, wax and lipids.

5. The system of claim 3, wherein the sanitary pipe fitting is a chemical process fitting and the optical sensor is fixed onto a transparent sight glass supporting a flow of the miscella.

6. The system of claim 3, wherein the light source is a laser source emitting an excitation wavelength between 200 nm-400 nm.

7. The system of claim 3, wherein the optical sensors and the light emitters are positioned at acute angles.

8. The system of claim 1, wherein a cross flow heat exchanger is provided that regulates the overall process temperature from 5 C to 35 C.

9. The system of claim 1 wherein a single flow enters the ultrafiltration membrane module and two flows exit the ultrafiltration membrane module, a first permeate flow is filtered by the ultrafiltration membrane and exits the system and a second retentate flow which circulates back to the ultrafiltration membrane module.
